(19) United States
(12) Patent Application Publication
(10) Pub. No.: US 2003/0132317 A1
(43) Pub. Date: Jul. 17, 2003

(54) Device and method for generating a system pressure in an injection unit

(76) Inventors: Dieter Kienzler, Leonberg (DE); Patrick Mattes, Stuttgart (DE); Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/181,480

(22) PCT Filed: Jan. 13, 2001
(86) PCT No.: PCT/DE01/00127

(30) Foreign Application Priority Data
Jan. 22, 2000 (DE) 100 02 705.9

(51) Int. Cl. F02M 59/00

(52) U.S. Cl. 239/533.2

(57) ABSTRACT

The invention proposes an injection apparatus (1) for fuel, with a system pressure region (14) in which a system pressure prevails and an injection pressure region (11) in which an injection pressure prevails, wherein the injection pressure is greater than the system pressure. The injection pressure region (11) and the system pressure region (14) communicate with each other by means of a throttle device (12, 13). The system pressure in the system pressure region (14) can be controlled by means of a system pressure valve (16). The invention also proposes a method for producing a system pressure in an injection apparatus for fuel.

### PRIOR ART

The invention relates to an injection apparatus for fuel, which has a system pressure region in which a system pressure prevails and an injection pressure region in which an injection pressure prevails, where the injection pressure is greater than the system pressure. The current invention also relates to a method for producing a system pressure in a fuel injection apparatus.

A device and method of this generic type are used, for example, in reservoir injection systems (so-called common rail injection systems) for diesel engines. In common rail injection, the pressure production and the injection are decoupled so that independent of the engine speed and the injection quantity, a high injection pressure of approx. 200 to 1800 bar (200×10⁵ to 1800×10⁵ Pa) is produced and is kept at the ready in the “rail” (fuel reservoir) for the injection. The fuel injection is then executed by means of an injection apparatus, for example a common rail injector. This can have a piezoelectric actuator and a hydraulic transmission. A so-called system pressure in the injection apparatus is required in order to assure that it functions properly in general. According to the prior art, the known injection apparatuses currently operate at a system pressure on the same order of magnitude as the normal ambient pressure or at a leak fuel pressure of approx. 1 bar (=10⁵ Pa).

When the ambient pressure or a leak fuel pressure is used, however, the filling of the region of the injection apparatus in which the system pressure prevails is not optimally assured. This is particularly due to the insufficient system pressure. In particular, there are often difficulties during starting procedures of the system. To this extent, malfunctions due to insufficient filling of the system pressure region cannot be completely eliminated.

### ADVANTAGES OF THE INVENTION

In the injection apparatus according to the invention, with the characterizing features of the main claim, the injection pressure region and the system pressure region are therefore connected to each other by means of a throttle device. A system pressure valve keeps the system pressure constant in the system pressure region. Consequently, by using the high injection pressure, which is reduced by a throttle device, a sufficient system pressure is assured in the injection apparatus. As a result, a sufficient filling of the system can also be achieved for starting procedures. The provision of a system pressure valve also assures that the system pressure does not become excessive, which could also lead to malfunctions of the injection apparatus. In addition to the sufficient filling, it is also advantageous that no separate device is required for producing a system pressure in the injection apparatus. Therefore, the manufacturing costs and in particular, the size of the injection apparatus can be kept to a minimum. In comparison with conventional injection apparatuses, therefore, all that is required are additional connecting bores, a throttle device, and a system pressure valve. Consequently, simple means can be used to achieve a sufficient filling of the system pressure region that is in particular also achieved during starting procedures.

A sufficient filling of the system pressure region can advantageously be achieved with a system pressure of approx. 10 to 50 bar (10×10⁵ to 50×10⁵ Pa). This also permits a reliable function of the injection apparatus to be achieved. Preferably, the injection pressure then lies between 200 and 1800 bar (200×10⁵ to 1800×10⁵ Pa).

Preferably, the injection apparatus is embodied as a common rail injector. The common rail injector has a piezoelectric actuator and a hydraulic transmission, which has a first and second transmission piston and a fluid chamber disposed between them. Consequently, the piezoelectric actuator can actuate the injection apparatus; the hydraulic transmission permits a temperature compensation due to a temperature-induced length change of the piezoelectric actuator.

It is also advantageous for the injection pressure region to be embodied as a fuel reservoir (rail).

Preferably, the throttle device is provided in the form of a piston element, which is disposed in a bore with a defined amount of play. As a result, a slight leakage from the injection pressure region to the system pressure region can be achieved.

Preferably, a clearance fit or a transition fit is provided between the bore and piston element provided as a throttle device. This permits a very precise determination of the pressure level in the system pressure region. A pin or the like can be used as the piston element. The level of the system pressure can be precisely determined by selecting a suitable fit with a defined tolerance.

The end of the first transmission piston oriented toward the piezoelectric actuator is advantageously also acted on by the system pressure.

In an alternative embodiment, the end of the transmission piston oriented toward the piezoelectric actuator can be acted on with leak fuel pressure. The leak fuel pressure is approx. 1 bar (10⁵ Pa). In particular, this achieves an optimal filling of the hydraulic transmission with minimal leakage, through the use of a system pressure; the system pressure is generated on the valve side.

The method according to the invention for producing a system pressure in a fuel injection apparatus includes the steps of producing a first pressure in a fuel reservoir (rail), throttling the first pressure by means of a throttle device to a predetermined system pressure, and maintaining the system pressure at the predetermined pressure value by means of a system pressure valve. Consequently, the first pressure prevailing in the fuel reservoir can advantageously be used to produce the system pressure of the injection apparatus in the system pressure region. This also assures a sufficient filling of the system pressure region of the injection apparatus during starting procedures. As a result, malfunctions can be eliminated. Furthermore, no additional pressure producing devices or the like are required to generate the system pressure. Furthermore, the system pressure can be maintained by means of a simply designed system pressure valve that functions as a safety device. If the system pressure is exceeded, the system pressure valve is simply opened, producing a connection to a leak fuel line. For example, a spring-loaded ball valve can be used as the system pressure valve. By and large, a structurally simple and reliable filling of the system pressure region can be achieved by using the reduced fuel reservoir pressure.

The system pressure adjusted by means of the throttle device advantageously lies between 10 and 50 bar.

Preferably, the method according to the invention uses a throttle device in the form of a piston element disposed in a bore with a defined amount of play. The system pressure prevailing in the system pressure region can then be adjusted by means of the play between the bore and the piston and also by means of the system pressure valve.

### DRAWINGS

The invention will now be explained with reference to the accompanying drawings, in conjunction with preferred exemplary embodiments.

FIG. 1 shows section through a common rail injection apparatus according to a first exemplary embodiment of the current invention and

FIG. 2 shows an enlarged sectional view of detail of a second exemplary embodiment according to the current invention.

### DESCRIPTION OF THE EXEMPLARY EMBODIMENTS

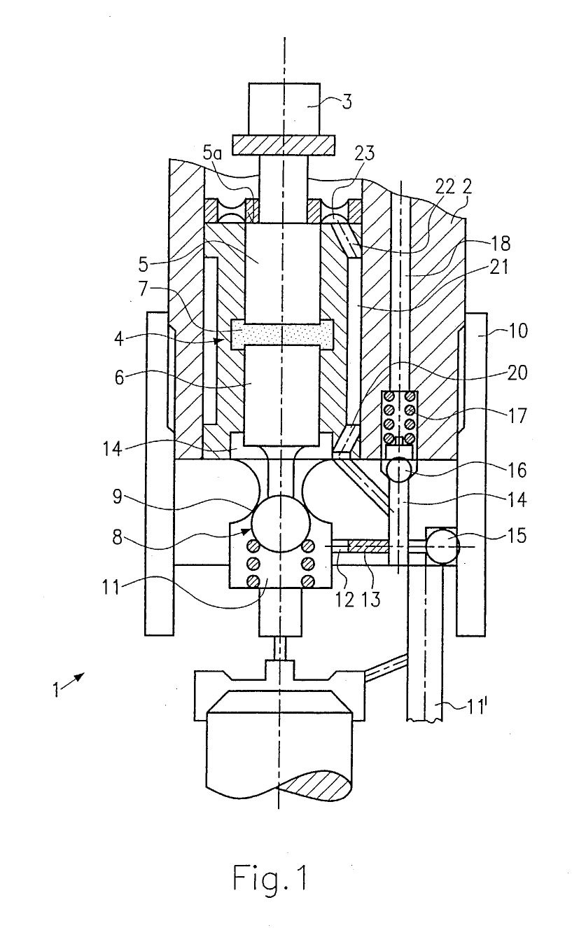

FIG. 1 shows a schematic section through a common rail injection apparatus (CR injection apparatus) according to a first exemplary embodiment of the current invention. The CR injection apparatus 1 has an injector body 2 with a central bore that contains a piezoelectric actuator 3 and a hydraulic transmission 4. The hydraulic transmission 4 is comprised of a first transmission piston 5, a second transmission piston 6, and a fluid chamber 7 disposed between the two transmission pistons 5, 6. The hydraulic transmission 4 can easily compensate for length changes of the piezoelectric actuator 3 due to temperature changes, without impairing the actuating precision of the CR injection apparatus. The second transmission piston 6 is provided with a control valve 8, which rests against a valve seat 9 and controls the injection of fuel into the piston chamber. A coupling nut 10 holds the injector body 2 together, which is comprised of three parts in this exemplary embodiment.

The common rail injection apparatus 1 also has an injection pressure region (high-pressure region) 11 and a system pressure region 14. The injection pressure region 11 communicates with the fuel reservoir (rail) and has a pressure range between 200 and 1800 bar (200×10⁵ to 1800×10⁵ Pa). For the sake of better visibility in FIG. 1, the high-pressure chamber labeled 11 is depicted in the same sectional plane as the rest of the depicted common rail injection apparatus, although the high-pressure line 11′ depicted in the lower part of FIG. 1 is actually offset from this due to spatial considerations.

As shown in FIG. 1, the injection pressure region 11 and the system pressure region 14 communicate with each other by means of a bore 12. The bore 12 contains a piston element 13, which cooperates with this bore 12 to produce a throttle device. To this end, a fit is provided between the bore 12 and the piston element 13, preferably a clearance fit or a transition fit. Depending on the fit between the bore 12 and the piston element 13, a certain size gap remains between the bore 12 and the piston element 13, which permits the throttle action to consequently be adjusted in a simple manner. In order to prevent the piston element 13 from being pushed out toward the system pressure region 14, a retaining device can also be provided on the side of the system pressure region. An external opening produced during production of the bore 12 is closed by means of a sealing ball 15.

The common rail injection apparatus 1 also has a system pressure valve 16, which is prestressed by a compression spring 17. If the pressure in the system pressure region 14 is higher than a defined pressure, then the system pressure valve 16 opens in opposition to the spring 17 and produces a connection to a leak fuel line 18. In this instance, the pressure in the leak fuel line is approx. 1 bar (10⁵ Pa). As soon as the pressure in the system pressure region 14 has reached a defined value again, the system pressure valve 16 closes and maintains the system pressure at the predetermined value.

As is also shown in FIG. 1, the system pressure prevailing in the system pressure region 14 also communicates with a surface 5a of the first transmission piston 5 by means of a connecting bore 20, a connecting section 21 disposed in hydraulic transmission 4, a connecting bore 22, and a cross-sectionally semicircular annular chamber 23. As a result of adjusted system pressure also prevails at the end of the transmission piston 5 oriented toward the piezoelectric actuator 3.

As explained above, the connection according to the invention of the injection pressure region 11 with the system pressure region 14 can assure that there is always a sufficient filling of fluid in the system pressure region 14. In particular, this also applies to starting procedures. Furthermore, a desired pressure in the system pressure region 14 can be produced through an appropriate choice of the fit between the piston element 13 and the bore 12 and an appropriate adjustment of the system pressure valve 16 that functions as a safety valve. No additional pressure producing devices are required for this, which permits a simple and inexpensive design of the injection apparatus. The system pressure can therefore be produced simply by using the pressure that is already present because of the rail.

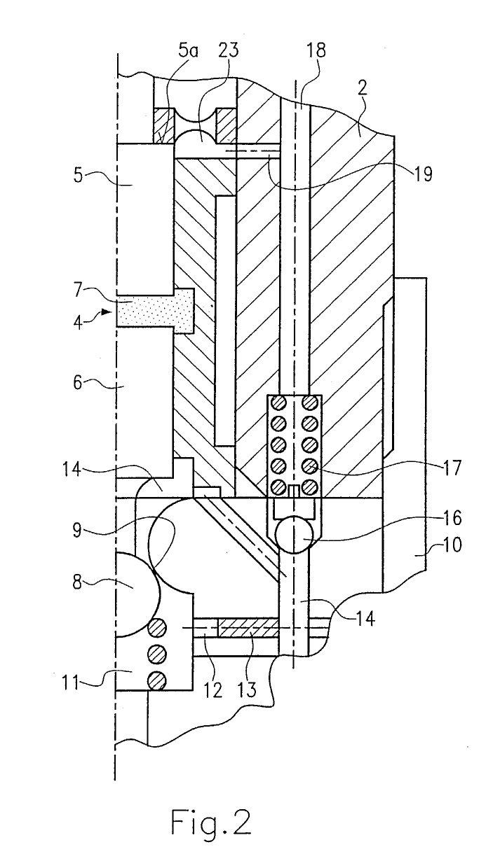

FIG. 2 schematically depicts a second exemplary embodiment according to current invention. Parts, which correspond to the first exemplary embodiment of the injection apparatus, are provided with the same reference numerals.

In contrast to the first exemplary embodiment, in the second exemplary embodiment, the top 5a of the first transmission piston 5 is not acted on with the system pressure. In other words, the system pressure region 14 does not communicate with the top 5a of the transmission piston 5. Instead, the top 5a of the first transmission piston 5 communicates with the leak fuel line 18 by means of a connecting bore 19. As a result, the leak fuel pressure of approx. 1 bar (10⁵ Pa) prevails at the end of the transmission piston 5 oriented toward the piezoelectric actuator 3. This offers the additional advantage of an optimal filling of the transmission with minimal leakage, through the use of the system pressure generated on the valve side.

1. An injection apparatus (1) for fuel, with a system pressure region (14) in which a system pressure prevails and an injection pressure region (11) in which an injection pressure prevails, wherein the injection pressure is greater than the system pressure, characterized in that the injection pressure region (11) and the system pressure region (14) communicate with each other by means of a throttle device (12, 13), and the system pressure can be controlled by means of a system pressure valve (16).

2. The injection apparatus according to claim 1, characterized in that the system pressure lies between 10 and 50 bar.

3. The injection apparatus according to claim 1 or 2, characterized in that the injection pressure in the injection pressure region (11) lies between 200 and 1800 bar.

4. The injection apparatus according to one of claims 1 to 3, characterized in that the injection apparatus is embodied as a common rail injection apparatus with a piezoelectric actuator (3) and a hydraulic transmission (4), wherein the hydraulic transmission (4) has at least a first transmission piston (5), a second transmission piston (6), and a fluid chamber (7) disposed between them.

5. The injection apparatus according to one of claims 1 to 4, characterized in that the injection pressure region (14) is embodied as a fuel reservoir (rail).

6. The injection apparatus according to one of claims 1 to 5, characterized in that the throttle device is embodied as a piston element (13) disposed in a bore (12) with a defined amount of play.

7. The injection apparatus according to claim 6, characterized in that depending on the predetermined system pressure, a clearance fit or a transition fit is provided between the bore (12) and the piston element (13).

8. The injection apparatus according to one of claims 1 to 7, characterized in that an end (5a) of the first transmission piston (5) oriented toward the piezoelectric actuator (3) is acted on with system pressure.

9. The injection apparatus according to one of claims 1 to 7, characterized in that the end (5a) of the first transmission piston (5) oriented toward the piezoelectric actuator (3) is acted on with a leak fuel pressure of approx. 1 bar.

10. A method for producing a system pressure in an injection apparatus for fuel, characterized by means of the following steps:
production of a first pressure in an injection pressure region (11),
throttling of the first pressure down to the system pressure by means of a throttle device (12, 13), and
maintaining the system pressure at a predetermined pressure value by means of a system pressure valve (16).

11. The method according to claim 10, characterized in that the throttle section is produced by means of a piston element (13), which is disposed in a bore (12) with a predetermined amount of play between the bore (12) and the piston element (13).
